(19) United States
(12) Patent Application Publication
(10) Pub. No.: US 2007/0116620 A1
(43) Pub. Date: May 24, 2007

(54) Halide scavengers for high temperature applications

(76) Inventors: Vladislav I. Kanazirev, Arlington Heights, IL (US); Jayant K. Gorawara, Buffalo Grove, IL (US); Henry Rastelli, Gurnee, IL (US); Peter Rumfola III, Bueche, LA (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/283,949

(22) Filed: Nov. 21, 2005

(51) Int. Cl. B01D 53/68

(52) U.S. Cl. 423/240 S; 502/414

(57) ABSTRACT

A composite sorbent is formed which is the reaction product of a solid alkali metal carbonate, rehydratable alumina and water or an aqueous solution of a metal salt. The reaction between the components occurs while forming particulates followed by curing and activation at high temperatures. The alkali metal in the sorbent exhibits a highly reactive and accessible state that is very favorable for various sorption applications. The sorbent is especially useful for removal of HCl and other acid contaminants from gas and liquid hydrocarbon streams at high temperatures.

### FIELD OF THE INVENTION

The present invention relates to halide scavengers and their use for treating gas and liquid streams. More particularly, the present invention relates to a process of using a sorbent for removing HCI from high temperature gas and liquid streams, especially in the production of synthesis gas.

### BACKGROUND OF THE INVENTION

Acid gases are present as impurities in numerous industrial fluids, i.e., liquid and gas streams. These acid gases include hydrogen halides such as HCl, HF, HBr, HI and mixtures thereof. Hydrogen chloride is a problem in particular. Usually, HCl is removed at ambient temperature with alkali metals modified alumina or metal oxide (mostly ZnO) sorbents. On the other hand, high temperature chloride scavengers are needed for some industrial applications such as the production of hydrogen by steam reforming of hydrocarbons. In these applications, the hydrocarbon feed first passes through a hydrodesulfurization (HDS) or hydrogenation stage that converts the organo-chloride contaminants to HCl. Since the HDS process operates at 350° to 400° C., it is advantageous if the next stage of chloride scavenging also occurs at a high temperature.

Use of alumina loaded with alkali metals as an HCl scavenger is the current “state of the art” solution for the purification of hydrocarbon streams at high temperatures. However, the standard zinc oxide based sorbents cannot be applied in such applications because of the volatility of the resulting zinc chloride product.

The existing sorbents for high temperature applications need improvements in terms of chloride loading, reduced reactivity towards the main stream and physical stability in service.

Alumina modified with alkali or alkaline earth elements is known as a good chloride scavenger. Recently, Blachman disclosed in U.S. Pat. No. 6,200,544 an adsorbent for removing HCl from fluid streams comprising activated alumina impregnated with alkali oxide and promoted with phosphates, organic amines or mixtures thereof.

In an attempt to increase the adsorbent performance, U.S. Pat. No. 5,897,845 assigned to ICI claimed absorbent granules comprising an intimate mixture of particles of alumina trihydrate, sodium carbonate or sodium bicarbonate or mixtures thereof and a binder wherein the sodium oxide (Na₂O) content is at least 20% by weight calculated on an ignited (900° C.) base. This material was designated for use at temperatures below 150° C.

Generally, HCl in gas or liquid hydrocarbon streams must be removed from such streams to prevent unwanted catalytic reactions and corrosion to process equipment. Furthermore, HCl is considered a hazardous material and releasing the HCl to the environment must be avoided.

The disadvantages of the existing industrial HCl scavengers are as follows:

There are two main classes of HCl scavengers. The first group comprises the alkali or alkaline-earth doped aluminas. The alkali metal content of these adsorbents calculated as an oxide (Na₂O) is typically between 8 and 10%. The scavengers of this group achieve a relatively low Cl loading, typically 7 to 9%. The second group consists of intimate mixtures of alumina, carbonate (bicarbonate) and binder. A typical material from this group is described in U.S. Pat. No. 5,897,845. The Na₂O content is at least 20 mass%, which determines the high potential Cl loading of this material. However, scavengers of this type cannot be used at temperatures higher than 150° C. They have low BET surface area and insufficient porosity to provide high loading and the inability to function at the high temperatures present in certain applications. For example, in the '845 patent, minimum BET surface area is greater than 10 m²/g and one commercial product that is intended for high temperature chloride removal has a BET surface area of about 66 m^{2/}g. Accordingly, there remains a need for improved halide scavengers with high loading capacity that can operate at high temperatures, such as above 150° C.

### SUMMARY OF THE INVENTION

The composite sorbents prepared according the present invention have significant advantages over the prior art since they are low cost materials exhibiting high BET surface area and porosity along with a high content of active component. These properties translate to high dynamic capacity in HCl removal from both gas and liquid fluids. A further advantage compared to some other prior art sorbents is that the sorbents of this invention do not require a separate binder to be added to the mixture in the forming process. They have sufficient mechanical stability in both fresh and spent state along with low reactivity towards the main stream. The invention comprises a process for making an adsorbent and the uses that can be made of this adsorbent. One method of preparation of the adsorbent comprises mixing at least one alumina compound with a solid metal carbonate and adding or spraying water on the mixture. In the practice of the present invention, the term “carbonate” includes inorganic compounds containing a CO₃ moiety including a bicarbonate or a basic carbonate. Then the mixture is allowed to stay at ambient conditions to cure or is maintained at an elevated temperature between about 25° to 150° C. for a period long enough for the materials to react. The appropriate combination of reaction time and temperature can be readily determined by one skilled in the art. A longer time is needed at lower temperatures within the stated range. In addition, in the practice of the present invention, a second step of thermal treatment follows the curing step. In this thermal treatment that is a reactive cure, a temperature between 250° and 500° C. is needed in order to compose the material formed in the first step resulting in a reactive species that is useful in scavenging HCl in high temperature applications. Preferably the temperature is between 320° and 480° C. The sorbent has a BET surface area of from about 50 to 200 m²/g and typically comprises about 10 to 25 mass % Na₂O. A particularly useful carbonate is a sesquicarbonate. The metal in the metal carbonate may be sodium, potassium, lithium, zinc, nickel, iron or manganese. Other metals may be used as known to those skilled in the art.

The invention also comprises a process for the removal of at least one hydrogen halide from a fluid or gaseous stream comprising hydrogen, hydrocarbons, water, or other gases such as nitrogen and hydrogen halide, wherein said process comprises contacting said fluid stream with a sorbent material in a packed bed, said sorbent material comprising a reaction product of at least one alumina and at least one solid metal carbonate. The solid metal carbonate is preferably at least one sesquicarbonate. The hydrogen halide is selected from the group consisting of hydrogen chloride, hydrogen fluoride, hydrogen iodide, hydrogen bromide and mixtures thereof. The invention is useful in the treatment of a fluid stream comprising a net hydrogen stream from a catalytic reforming process, where the hydrogen halide is hydrogen chloride. The invention is also useful in the treatment of a net hydrogen stream from a light paraffin dehydrogenation process where the hydrogen halide is also hydrogen chloride.

### DETAILED DESCRIPTION OF THE INVENTION

At least two solid and one liquid component are needed to produce the reactive composite sorbent of the present invention. At least one carbonate powder and at least one alumina powder comprise the solid components and water or an aqueous solution of at least one salt is the liquid component.

The carbonate powder is preferably an alkali metal carbonate in a powder form. Small particles, preferably about 5 to 10 microns in diameter, are employed. A carbonate component that has been found to provide excellent results in the present invention is the natural carbonate (soda ash) ore known as Trona or Nahcolite. A popular source of such natural carbonate is the Green River occurrence in Wyoming, US. The book NATURAL SODA ASH: OCCURRENCES, PROCESSING AND USE, authored by Donald E. Garrett, Van Nostrand Reinhold publication, 1992, summarizes important characteristics of natural carbonates. Other carbonates that can be used include Wegscheiderite (Na₂CO₃.NaHCO₃), Thermonatrite (Na₂CO₃.H₂O), Shortite (Na₂CO₃.2CaCO₃), and Eitelite (Na₂CO₃.MgCO₃).

One such carbonate that has been found especially useful is a natural sodium sesquicarbonate, marketed by Solvay Chemicals, Houston, Tex. as Solvay T-200®. A sesquicarbonate has a formula of Na₂CO₃.NaH CO₃.2H₂O. It produces 1.5 mols sodium carbonate (Na₂CO₃) upon heating at sufficiently high temperature. Table 1 presents some properties of this product as reflected in the producer's technical data sheet.

TABLE 1

| Component | Typical Analysis |
|---|---|
| Na₂CO₃•NaHCO₃•2H₂O | 97.5% |
| Free Moisture | 0.01 |
| Water Insoluble | 2.3% |
| NaCl | 0.1 |
| Bulk Density | 785 kg/m³ (49.0 lbs/ft³) |
| Particle Size | |
| Sieve Opening, micrometers | Weight Percent |
| <70 | 75 |
| <28 | 50 |
| 6 | 10 |

The carbonate raw material was found to have a typical FTIR (Fourier Transform Infrared) spectrum characterized with absorbance peaks at about 3464, 3057, 1697, 1463, 1190, 1014, 850 and 602 cm⁻¹, corresponding to the values published for this material. The final product of the present invention had an FTIR spectra exhibiting at least two peaks selected from absorbance peaks at 880, 1103, 1454, 1410, 1395, 1570, and 1587 cm⁻¹.

An alumina powder that has been found to be useful in the present invention is a transition alumina powder produced by the rapid calcination of Al(OH)₃, known as Gibbsite. Alumina A-300, sold by UOP LLC, Des Plaines, Ill., is a typical commercial product that is suitable as a component of the reactive composite of the present invention. This alumina powder has a BET surface area of about 300 m²/g and about 0.3 mass % Na₂O. It contains only a few percent free moisture and is capable of fast rehydration in the presence of water. The FTIR spectrum of A-300 has the broad absorbance peaks due to Al-O vibration at about 746 and 580 cm⁻¹, with only a few additional peaks of OH (3502 and 1637 cm⁻¹) and CO₃ of surface carbonate species (1396 and 1521 cm⁻¹) are present.

The third component is water, or optionally an aqueous solution of a salt, which plays an important role in facilitating a reaction between the carbonate and alumina powder. The preferred salts include metal salt is selected from the group consisting of sodium acetate, sodium oxalate and sodium formate. The preferred average particle size D50 for the alumina component and the carbonate ingredient is from about 5 to 12 μm, although larger particles may be used, especially for the carbonate ingredient. The alumina and the sesquicarbonate are present in a ratio of about 0.8 to about 5. Preferably, the alumina and the sesquicarbonate are present in a ratio of about 2 to 4.

It has been found that that there is no reaction between the sesquicarbonate and alumina when a mixture is heated in a dry state to about 100° C. However, heating the dry mix to an initial temperature of from 300° up to 600° C. converts the sesquicarbonate to sodium carbonate. In contrast, the presence of additional water followed by brief calcination at 100° C. triggers a reaction between the sesquicarbonate and alumina. The product was found to be Dawsonite crystals having a particle size of less than about 0.02 micrometers. In the present invention, thermal treatment at temperatures of at least 250° C. and up to about 500° C. has been found to produce an adsorbent that is very effective in removal of acid halides at high temperatures. Preferably this thermal treatment or reactive cure is at a temperature that is equal to or exceeds the temperature that the sorbent is decided to operate at in removal of acid halides. Example 1 describes the process to produce this phenomenon.

### EXAMPLE 1

A four foot rotating pan was used as a forming device to feed continuously 0.5 lbs (0.227 kg)-0.6 lbs(0.272 kg)/min of T-200® powder, 0.9 lbs (0.408 kg)-1.2 lbs (0.544 kg)/min A-300 alumina powder and 0.3 lb (0.136 kg)-0.7 lbs( 0.318 kg)/min water. Some granular alumina was placed in the pan to act as a seed before the forming process started. The product beads were collected and cured overnight at ambient conditions. Then, a 5×8 mesh fraction was activated in an air circulated oven at about 400° C. Three samples labeled as Samples 1, 2, and 3 were produced by varying the feed ratios and the forming conditions. One additional sample labeled 4 was produced by using sodium acetate solution instead of water as a nodulizing liquid. Table 2 lists selected properties of all samples used.

TABLE 2

| | Bulk density | BET surface | Na₂O content |
|---|---|---|---|
| Sample | lbs/ft³ (kg/m³) | area, m²/g | mass-% |
| 3 | 46.3 (741.7) | 179 | 12.6 |
| 1 | 42.2 (676.0) | 145 | 13.2 |
| 2 | 43 (688.8) | not determined | 15.7 |
| 4 | 43.8 (701.6) | 75 | 20.9 |

### EXAMPLE 2

The HCl removal capability of the samples prepared according this invention were first measured in a McBain device consisting of a glass manifold where eight glass spring balances were attached. Each of these compartments could be heated separately while all of the samples, which were attached in small baskets to the balances, could be evacuated and then exposed to 5 torr HCl pressure for a period of up to 24 hours. The weight increase due to HCl pickup was then measured. A pressure control system kept the pressure constant in the course of this experiment and the HCl consumed was quickly replenished. Finally, the spent samples from the McBain device were analyzed to determine the Cl retained.

Table 3 summarizes the testing data for the samples of this invention and some reference samples. All samples were first activated under vacuum at 315° C. and then the HCl pick up experiment was done at 288° C. Samples 5-8 were samples of commercial products from four different suppliers.

TABLE 3

| | | | | Cl content |
|---|---|---|---|---|
| | | | | of spent |
| | | Weight | Weight | samples |
| | | increase upon | increase upon | by |
| | | HCl exposure | HCl exposure | chemical |
| | | after 1 hour | after 20 hours | analysis |
| Sample | Sample type | mass-% | mass-% | mass-% |
| 1 | this invention | 7.06 | 7.04 | 9.97 |
| 2 | this invention | 6.92 | 6.90 | 9.77 |
| 3 | this invention | 6.16 | 6.11 | 9.44 |
| 4 | this invention | 5.41 | 5.11 | 8.92 |
| 5 | commercial type | 8.74 | 8.27 | 8.75 |
| 6 | commercial type | 7.39 | 7.19 | 8.59 |
| 7 | commercial type | 8.40 | 7.96 | 8.19 |
| 8 | commercial type | 4.41 | 4.26 | 7.16 |

The data in Table 3 shows that the samples prepared according this invention have a higher Cl pick up at 288° C. than the commercial scavengers currently used in this application. Note that the weight change not always parallels the Cl analysis results. Since the McBain adsorption apparatus only measures gravimetric weight of the sample, some differences in weight change may be explained based upon some samples releasing volatile products such as CO₂ and H₂O upon uptake HCl.

### EXAMPLE 3

The data in Example 2 were obtained at static conditions which generally are not typical for the industrial applications. Hence, selected samples were compared in flow experiments for HCl pick up. About 55 cm³ of sample was charged in a tubular reactor (2.54 cm diameter) in each case whereas about 550 cm³/min gaseous blend of ˜1 vol-% HCl in nitrogen was flowing through the bed until a breakthrough (BT) in HCl occurred as measured by the pH change of a standard NaOH solution placed at the flow exit. The bed was then purged with pure nitrogen, cooled down and the spent particulates, which were distributed in 5 separate bed segments, were subjected to chemical analysis to determine the Cl loading. The samples were treated prior to HCl uptake experiments in pure nitrogen at 315° C. for at least 1 hour.

Table 4 shows the Cl pick up values as determined by analysis of spent samples from BT experiments.

TABLE 4

| | | Cl content of spent samples |
|---|---|---|
| | | by chemical analysis |
| Sample | Sample type | mass-% |
| 2 | this invention | 16.99 |
| 2 | repetition of above | 16.85 |
| 3 | this invention | 10.88 |
| 5 | commercial | 7.25 |
| 8 | commercial | 7.16 |

Table 4 provides evidence of the advantage of the scavengers of this invention against the commercially used high temperature Cl guards. The advantage is more pronounced at flow conditions of testing which are more relevant to the industrial conditions of use of such materials.

A material suitable for the application disclosed in this description is made by co-nodulizing a mixture of natural sesquicarbonate and rehydratable (flash calcined) alumina powders followed by curing and thermal activation. There are other practical ways to produce the scavenger of this invention. Preparing pellets of the solid mix followed by contacting with liquid is one of the possible approaches. Application of known extrusion techniques is another approach. The method of this invention is particularly unique since the solid components react during the forming and curing steps to re-disperse upon formation of a hydroxycarbonate compound. This compound decomposes upon thermal activation to yield species which prove very efficient for removal of chloride and other halides from gaseous streams at high temperatures. The testing data suggest that the Na₂O content of about 16 mass % provides the highest Cl loading although higher loading levels are possible.

What is claimed is:

1. A process for making a sorbent comprising mixing at least one alumina compound with a solid metal carbonate together with water to form a mixture, followed by heating said mixture to a temperature of about 25° C. to 150° C. for a period sufficient for said solid metal carbonate and said alumina to cure followed by a reactive cure at a temperature of between about 250° and 500° C. to form a reactive species.

2. The process of claim 1 wherein said solid metal carbonate is a sesquicarbonate compound.

3. The process of claim 1 wherein said metal is selected from the group consisting of sodium, potassium, lithium, zinc, nickel, iron and manganese.

4. The process of claim 2 wherein said alumina and said sesquicarbonate are present in a ratio of about 0.8 to about 5.

5. The process of claim 2 wherein said alumina and said sesquicarbonate are present in a ratio of about 2 to 4.

6. The process of claim 1 wherein said water further comprises an aqueous solution comprising a metal salt.

7. The process of claim 6 wherein said metal salt is selected from the group consisting of sodium acetate, sodium oxalate and sodium formate.

8. The process of claim 1 wherein said sorbent has a BET surface area from about 50 to 200 m²/g and comprises about 10 to 25 mass % Na₂O.

9. A process for the removal of at least one hydrogen halide from a gaseous or liquid stream wherein said process comprises contacting said gaseous or liquid stream with a sorbent material, said sorbent material comprising a composite of at least one alumina and at least one solid metal carbonate wherein said contacting occurs at a temperature from about 70° to 400° C.

10. The process of claim 9 wherein said gaseous or liquid stream comprises hydrocarbons.

11. The process of claim 9 wherein said hydrogen halide is selected from the group consisting of hydrogen chloride, hydrogen fluoride, hydrogen iodide, hydrogen bromide and mixtures thereof.

12. The process of claim 9 wherein the gaseous or liquid stream comprises a product stream of a synthesis gas reaction.

13. The process of claim 9 wherein said sorbent material was mixed with water or an aqueous solution of a metal salt and then activated at a temperature between about 250° and 500° C.

14. The process of claim 13 wherein said sorbent material is activated at a temperature from about 320° to 480° C.

15. The process of claim 9 wherein said solid metal carbonate is a hydroxycarbonate.

16. The process of claim 15 wherein said solid metal carbonate is a sesquicarbonate compound.

17. The process of claim 9 wherein said sorbent has a BET surface area from about 50 to 200 m²/g and comprises about 10 to 25 mass % Na₂O.

18. An adsorbent comprising a reaction product of a carbonate and an alumina having an FTIR spectrum exhibiting at least two peaks selected from the group of about 880, 1103, 1454, 1410, 1395, 1570, and 1587 cm⁻¹.
